(19) United States
(12) Patent Application Publication
(10) Pub. No.: US 2021/0397321 A1
(43) Pub. Date: Dec. 23, 2021

(54) DISPLAY APPARATUS AND TOUCH CONTROL METHOD

(71) Applicant: BOE Technology Group Co., Ltd., Beijing (CN)

(72) Inventors: Tian Meng, Beijing (CN); Zhihong Du, Beijing (CN); Wenbo Li, Beijing (CN); Xuebo Zhang, Beijing (CN)

(21) Appl. No.: 17/254,520

(22) PCT Filed: Jun. 24, 2020
(86) PCT No.: PCT/CN2020/098142

§ 371 Date: Dec. 21, 2020

(30) Foreign Application Priority Data
Jun. 26, 2019 (CN) 201910561873.2

(51) Int. Cl. G06F 3/041

(52) U.S. Cl. CPC G06F 3/04164

(57) ABSTRACT

A display apparatus, including: a first touch screen; and a touch device including a touch portion and an electrical connection portion. The touch portion is on a side of the first touch screen and is electrically connected to the first touch screen through the electrical connection portion. The touch portion is configured to generate an electrical signal in response to a touch operation of a user on the touch portion, and provide the generated electrical signal to the first touch screen through the electrical connection portion to perform a touch control operation.

### CROSS-REFERENCE TO RELATED APPLICATION

This application claims priority to Chinese Patent Application No. 201910561873.2, filed on Jun. 26, 2019, which is incorporated herein by reference in its entirety.

### TECHNICAL FIELD

The present disclosure relates to a field of touch technology, and in particular to a screen-side touch device, a screen-side touch method, and a display apparatus.

### BACKGROUND

Nowadays, mobile terminal apparatuses represented by mobile phones have become indispensable items in people's daily life, and are used very frequently. When using mobile terminal apparatus, users generally touch a touch screen located on a front of the mobile terminal apparatus with their fingers to perform operations on the mobile terminal apparatus. In daily use, many users are accustomed to operating large-screen mobile phones with one hand. Common functions such as page turning and refreshing require touch operations such as sliding up and down on the touch screen.

### SUMMARY

An aspect of the present disclosure provides a display apparatus, including: a first touch screen; and a touch device including a touch portion and an electrical connection portion, wherein the touch portion is arranged on a side of the first touch screen and is electrically connected to the first touch screen through the electrical connection portion, and wherein the touch portion is configured to generate an electrical signal in response to a touch operation of a user on the touch portion and provide the generated electrical signal to the first touch screen through the electrical connection portion to perform a touch control operation.

In some embodiments, the first touch screen is a capacitive touch screen, and wherein the touch portion includes at least two conductive units electrically isolated from each other, with one ends of the conductive units electrically connected to the first touch screen through the electrical connection portion, and the other ends of the conductive units arranged in parallel on a side of the first touch screen.

In some embodiments, the other ends of the conductive units are arranged in a direction parallel or perpendicular to a side of the first touch screen.

In some embodiments, the electrical connection portion includes a plurality of connection pads, and the one ends of the at least two conductive units are electrically connected to the first touch screen through the plurality of connection pads, respectively; and wherein the touch device further includes a flexible substrate configured to fix the touch portion to a side of the first touch screen and fix the connection pads on the first touch screen.

In some embodiments, the display apparatus further includes a sealing protection layer covering the at least two conductive units and the connection pads, wherein the sealing protection layer seals the at least two conductive units and the connection pads as a whole.

In some embodiments, the display apparatus further includes a touch screen protection film, wherein the electrical connection portion and at least a part of the touch portion are between the touch screen protection film and the first touch screen.

In some embodiments, the display apparatus further includes an apparatus protection housing, wherein the first touch screen and the touch device are inside the apparatus protection housing, and the apparatus protection housing is provided with a through hole configured to expose the touch portion of the touch device.

In some embodiments, the touch device further includes a transition portion, and the touch portion and the electrical connection portion are connected through the transition portion.

In some embodiments, the display apparatus further includes a processor inside the display apparatus, wherein the processor is connected to the first touch screen and is configured to: receive an electrical signal generated by the touch operation, determine whether the touch operation meets a preset trigger condition or not, and if the touch operation meets the preset trigger condition, generate a control instruction based on the electrical signal and transmit the control instruction to the first touch screen.

In some embodiments, the preset trigger condition includes that whether the touch operation is at least one of sliding and throwing or not.

In some embodiments, the first touch screen includes a main control area and a touch connection area, and the electrical connection portion of the touch device is electrically connected to the first touch screen in the touch connection area; and wherein the processor is further configured to determine positions of a start touch point and an end touch point of the touch operation performed on the first touch screen, and perform a touch control operation according to a result of determination.

In some embodiments, the processor is configured to determine whether the start touch point and the end touch point are in one of the main control area and the touch connection area or not; and wherein if it is determined that the start touch point and the end touch point are in one of the main control area and the touch connection area, performing the touch control operation of the main control area or the touch connection area; and if it is determined that the start touch point and the end touch point are not in one of the main control area and the touch connection area, performing no operation.

In some embodiments, the performing the touch control operation of the main control area or the touch connection area includes: determining whether the start touch point and the end touch point are in the main control area or in the touch connection area; and wherein if it is determined that the start touch point and the end touch point are both in the main control area, performing the touch control operation of the main control area; and if it is determined that the start touch point and the end touch point are both in the touch connection area, performing the touch control operation of the touch connection area.

In some embodiments, the touch portion is a second touch screen connected to a processor inside the display apparatus; and the second touch screen is configured to generate an electrical signal in response to a touch operation of the user on the second touch screen and transmit the electrical signal to the processor to cause the processor to transmit a control signal to the second touch screen to perform a touch control operation on the second touch screen.

In some embodiments, the touch operation includes at least one of sliding and throwing.

Another aspect of the present disclosure further provides a touch control method implemented by the display apparatus described above, including: generating an electrical signal in response to a touch operation of a user on the touch device; and performing a touch control operation based on the electrical signal.

In some embodiments, the method further includes: determining positions of a start touch point and an end touch point when the touch operation is performed on the first touch screen; and performing the touch control operation based on a result of determination.

In some embodiments, the first touch screen includes a main control area and a touch connection area, and the electrical connection portion of the touch device is electrically connected to the first touch screen in the touch connection area. The method further includes: determining whether the start touch point and the end touch point are in one of the main control area and the touch connection area or not; and wherein if it is determined that the start touch point and the end touch point are in one of the main control area and the touch connection area, performing the touch control operation of the main control area or the touch connection area; and if it is determined that the start touch point and the end touch point are not in one of the main control area and the touch connection area, performing no operation.

In some embodiments, the performing the touch control operation of the main control area or the touch connection area includes: determining whether the start touch point and the end touch point are in the main control area or in the touch connection area; and wherein if it is determined that the start touch point and the end touch point are both in the main control area, performing the touch control operation of the main control area; and if it is determined that the start touch point and the end touch point are both in the touch connection area, performing the touch control operation of the touch connection area.

In some embodiments, the touch portion is a second touch screen connected to a processor inside the display apparatus, and the second touch screen is configured to generate an electrical signal in response to the touch operation of the user on the second touch screen and transmit the electrical signal to the processor to cause the processor to transmit a control signal to the second touch screen to perform a touch control operation on the second touch screen.

In some embodiments, the second touch screen is configured to generate the electrical signal in response to the touch operation of the user on the second touch screen perform operations including at least one of sliding and throwing on the second touch screen.

### BRIEF DESCRIPTION OF THE DRAWINGS

FIG. 1 is a schematic plan view of a display apparatus according to an embodiment of the present disclosure.

FIG. 2a is a schematic structure diagram of a touch device according to an embodiment of the present disclosure.

FIG. 2b is a schematic structure diagram of a touch device according to another embodiment of the present disclosure.

FIG. 3 is a schematic structure diagram of combining the touch device with a protection film according to an embodiment of the present disclosure.

FIG. 4a is a cross-sectional view taken along line A-A′ of the touch device according to the embodiment of the present disclosure shown in FIG. 2a.

FIG. 4b is a schematic diagram of an apparatus protection housing with a through hole.

FIG. 5 is another schematic plan view of the display apparatus according to an embodiment of the present disclosure.

FIG. 6a is a schematic diagram of a first touch gesture determination logic provided by an embodiment of the present disclosure.

FIG. 6b is a schematic diagram of a second touch gesture determination logic provided by an embodiment of the present disclosure.

FIG. 6c is a schematic diagram of a third touch gesture determination logic provided by an embodiment of the present disclosure.

FIG. 7 is a schematic structure diagram of a display apparatus according to another embodiment of the present disclosure.

FIG. 8 is a schematic flowchart of a touch control method according to an embodiment of the present disclosure.

FIG. 9 is a schematic flowchart of a touch control method according to an embodiment of the present disclosure.

FIG. 10 is a block diagram of the display apparatus according to an embodiment of the present disclosure.

### DETAILED DESCRIPTION OF EMBODIMENTS

In order to make the objectives, technical solutions and advantages of the present disclosure more apparent, the present disclosure will be further described in detail below in connection with specific embodiments and with reference to the drawings.

It should be noted that all the expressions “first” and “second” in the embodiments of the present disclosure are used to distinguish two different entities or parameters with same name. The expressions “first” and “second” are only for the convenience of presentation and should not be understood as a limit to the embodiments of the present disclosure. This will not be repeated in subsequent embodiments.

At present, a capacitive touch screen used in a mobile terminal is based on a touch principle of generating parasitic capacitance and changing an original electric field of the screen by touching the screen with a finger. A touch chip performs precise positioning by detecting changes in the electric field, and then transmits touch position data to a control chip of the terminal apparatus so as to control the touch screen. In practical use, when holding in one hand a mobile phone or other apparatus with touch screen, users like to slide the touch screen up and down with their thumbs.

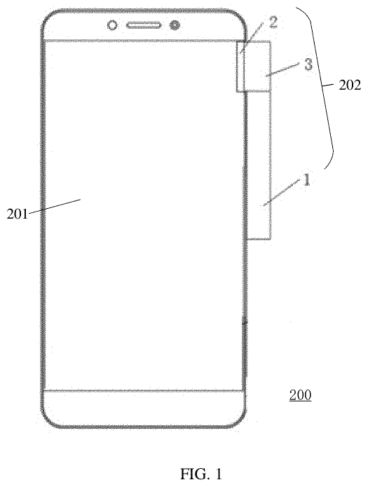

In order to solve a problem of user's joint strain caused by sliding the touch screen up and down with the thumb for a long time, as shown in FIG. 1, a first aspect of embodiments of the present disclosure proposes a display apparatus 200, including: a first touch screen 201; and a touch device 202 including a touch portion 1 and an electrical connection portion 2. The touch portion 1 is arranged on a side of the first touch screen 201 and is electrically connected to the first touch screen 201. The touch portion 1 is configured to generate an electrical signal in response to a touch operation of a user on the touch portion 1, and provide the generated electrical signal to the first touch screen through the electrical connection portion 2, so as to achieve an operation on the first touch screen.

It can be seen that the screen-side touch device provided by the embodiment of the present disclosure fixes the touch portion 1 to a side wall of the apparatus when in use. When the user's finger operates the touch portion 1 located on the side wall of the apparatus, the touch portion 1 senses the touch operation from the user's finger and generates an electrical signal matching the touch operation. Since the touch device is electrically connected to the first touch screen, a touch signal corresponding to the electrical signal is generated and transmitted to the first touch screen to perform an operation on the first touch screen. The screen-side touch device provided by the embodiment of the present disclosure provides a new touch operation method, which on the one hand avoids obstructing the user's sight when operating the first touch screen and improves the user experience, and on the other hand reduces the possibility of user's joint strain caused by sliding the first touch screen up and down with the thumb for a long time.

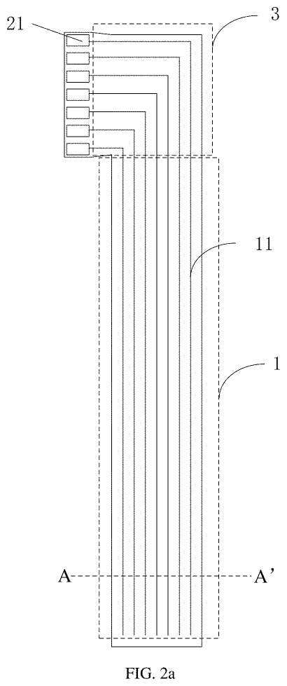

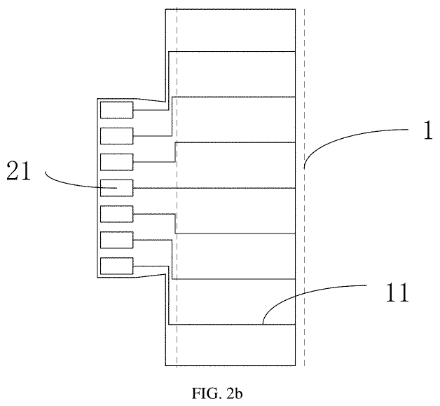

In some embodiments, the first touch screen is a capacitive touch screen. As shown in FIGS. 2a and 2b, the touch portion 1 includes at least two conductive units 11 insulated from each other. One ends of the conductive units 11 are electrically connected to the first touch screen, and the other ends of the conductive units 11 are arranged in parallel on a side of the first touch screen. For example, two adjacent conductive units 11 are arranged in parallel, and the conductive units 11 may be made of metal wire, conductive cotton or other conductive materials that may be arranged in a parallel structure. When in use, the conductive units 11 sense the touch operation from the user and generate a corresponding electrical signal. The electrical signal is transmitted to the first touch screen through the conductive units 11, so as to perform a touch control operation on the first touch screen.

For example, the other ends of the conductive units 11 are arranged in a direction parallel or perpendicular to the side of the apparatus with the touch screen. FIG. 2a is a schematic structure diagram of the screen-side touch device according to an embodiment of the disclosure. In this embodiment, the conductive units 11 are arranged parallel to the side of the first touch screen. In this case, the finger slides in a direction perpendicular to the touch screen. When the finger slides from a front of the terminal apparatus to a back thereof, it is equivalent to that the finger slides from bottom to top on the touch device, that is, it is equivalent to sliding from bottom to top on the first touch screen. FIG. 2b is a schematic structure diagram of the screen-side touch device according to another embodiment of the present disclosure. In this embodiment, the conductive units 11 are arranged perpendicular to the side of the first touch screen. In this case, the finger slides in a direction parallel to the side of the first touch screen. When the finger slides from bottom to top, it is equivalent to sliding from bottom to top on the first touch device.

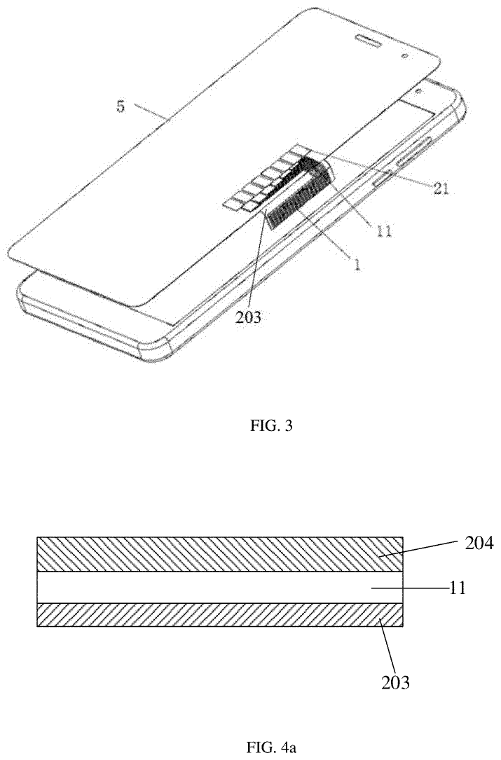

In some other embodiments, one ends of the conductive units 11 are provided with connection pads 21 (hereinafter referred to as “electrical contact points 21”) for electrical connection with the first touch screen. As shown in FIG. 3, the display apparatus further includes a flexible substrate 203 (hereinafter referred to as “adhesive structure 203”) for fixing the touch portion 1 to a side surface of the first touch screen 201 and fixing the electrical contact points 21 to the first touch screen. For example, the adhesive structure may be back glue or rubber sleeve, such as transparent glue, double-sided glue, or the like. In this embodiment, the user directly touches the touch device, and electrical signals generated on the conductive units 11 are transmitted to the first touch screen 201 through the electrical contact points 21, so that the first touch screen 201 generates parasitic capacitance and a touch signal is generated to perform a touch control operation on the first touch screen 201.

As shown in FIGS. 2a and 2b, the touch portion 1 includes seven conductive units 11 arranged parallel to each other. Each of the conductive units 11 has a corresponding electrical contact point 21. When a finger slides on the touch portion 1 in a tangential direction of the conductive units 11, electrical signals are generated among the conductive units 11. The generated electrical signals are transmitted along the conductive units 11 to the corresponding electrical contact points 21, and then transmitted through the electrical contact points 21 to the first touch screen 201 in contact with the electrical contact points 21. It is equivalent to transmitting a sliding signal on the touch portion 1 to the first touch screen 201, thereby performing a sliding operation on the first touch screen 201.

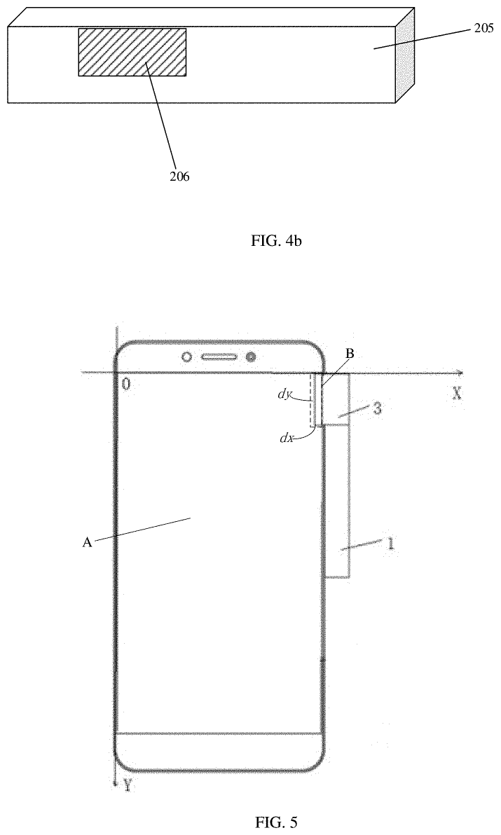

In some embodiments of the present disclosure, as shown in FIG. 4a, the display apparatus further includes a sealing protection layer 204 arranged on an outer surface of the conductive units 11 and the electrical contact points 21. The sealing protection layer 204 seals the at least two conductive units 11 and the corresponding electrical contact points 21 as a whole to prevent the conductive units 11 and the electrical contact points 21 from being exposed to the outside, while accommodates and supports the conductive units 11 and the electrical contact points 21. In some embodiments, the sealing protection layer may be a glass protection layer, or a protection layer made of PP, PVC, PET, AR, or the like, which may not only protect the conductive units 11 and the electrical contact points 21, but also ensure that the conductive units 11 may sense the touch operation of the finger.

In some embodiments, as shown in FIG. 3, the screen-side touch device further includes a touch screen protection film 5. The touch portion 1 is electrically connected to a surface of the touch screen protection film 5, and the touch screen protection film 5 is attached to the first touch screen such that the touch portion 1 is in electrical contact with the first touch screen. For example, the electrical contact points 21 of the screen-side touch device are arranged on an edge of an inner surface or an outer surface of the touch screen protection film 5. When the touch screen protection film 5 is attached to the touch screen, the electrical contact points 21 are in contact with the first touch screen, such that an electrical signal generated by the touch device may be transmitted to the first touch screen. In this embodiment, the electrical contact points 21 of the screen-side touch device may be fixed to a right edge of the touch screen protection film 5, or may be fixed to a left edge of the touch screen protection film 5. During manufacturing, different sizes and positions may be designed to combine the protection film and the touch device according to different manufacturers and models of mobile terminal apparatus, which provides a healthier touch device for users, enriches functions of mobile apparatus protection film, and improves the overall value of the product.

In other embodiments, as shown in FIG. 4b, the touch device further includes an apparatus protection housing 205. The touch portion 1 is arranged inside the apparatus protection housing 205. The apparatus protection housing 205 is provided with a through hole 206 for exposing the touch portion 1. The electrical contact points 21 are arranged on an inner surface of the apparatus protection housing 205, so that when the apparatus protection housing 205 is installed on the apparatus with the touch screen, the electrical contact points 21 are in electrical contact with the first touch screen. On the one hand, the protection housing may protect the terminal apparatus, and on the other hand, it may also fix the screen-side touch device to the terminal apparatus.

In other embodiments, as shown in FIGS. 1, 2a and 2b, the touch device further includes a transition portion 3, through which the touch portion 1 and the electrical connection portion 2 are connected. In some embodiments, the transition portion 3 includes a plurality of conductive connection wires, which are connected to the conductive units in a one-to-one correspondence. In some embodiments, the conductive connection wires and the conductive units may be implemented as a continuous second conductive unit. However, as an arrangement of the conductive connection wires in the transition portion 3 is different from an arrangement of the conductive units in the touch portion 1, a signal generated when the finger touches the transition portion 3 may be different from a signal when the touch portion 1 is touched. In order to avoid a bad user experience, it is designed to paint the transition portion 3 and the touch portion 1 with different colors to distinguish, or directly cover an outer surface of the transition portion 3 with an insulating layer, such that the conductive connection wires inside the transition portion 3 do not generate a capacitive signal when the finger touches the transition portion 3, which avoids a bad user experience caused by failing to generate a correct electrical signal to operate the touch screen when the user touches the transition portion 3.

According to the user's touch habits, the user rarely operates an upper right corner area of the first touch screen. Therefore, the electrical contact points 21 may be arranged in the upper right corner area of the first touch screen, and the touch portion 1 may be fixed to a right side wall of the apparatus. At the same time, in order not to affect the normal use of the user, a size of the area in which the electrical contact points 21 are located is reduced as much as possible. For example, a longitudinal length of the area in which the electrical contact points 21 are located is set to 10% of a length of the entire first touch screen, and a transverse length of the area in which the electrical contact points 21 are located is set to 1% of a width of the entire first touch screen, so that the user hardly touches the area in which the electrical contact points 21 are located during use. As shown in FIG. 5, the transverse length of the area in which the electrical contact points 21 are located is dₓ and the longitudinal length of the area in which the electrical contact points 21 are located is d_{y}, a transverse dimension of the first touch screen is Xₘₐₓ, and a longitudinal dimension of the first touch screen is Yₘₐₓ, where dₓ=Xₘₐₓ*1%, d_{y}=Yₘₐₓ*10%. Accordingly, an effective area of a contact range in which the area where the electrical contact points 21 are located is in contact with the first touch screen has four coordinate points of (Xₘₐₓ−dₓ,0), (Xₘₐₓ−dₓ,d_{y}), (Xₘₐₓ,0), (Xₘₐₓ,d_{y}). With a gradual increase of touch screen of mobile terminal apparatus, users are generally accustomed to operating a middle area of the touch screen and rarely operate edges of the touch screen. Therefore, the area in which the electrical contact points 21 of the screen-side touch device according to the embodiment of the present disclosure are located is not limited to being fixed to the upper right corner of the first touch screen, and may be fixed to any side of the first touch screen. For example, the area in which the electrical contact points 21 are located may be fixed to a left edge of the first touch screen, and the touch portion 1 may be fixed to a left side wall of the mobile terminal apparatus. In this case, if the user holds the mobile terminal apparatus with his right hand, he may operate the touch portion 1 with his right index finger, middle finger or even ring finger. In this way, the user is provided with a variety of operation methods to reduce the possibility of joint strain caused by sliding the touch screen up and down through the thumb for a long time.

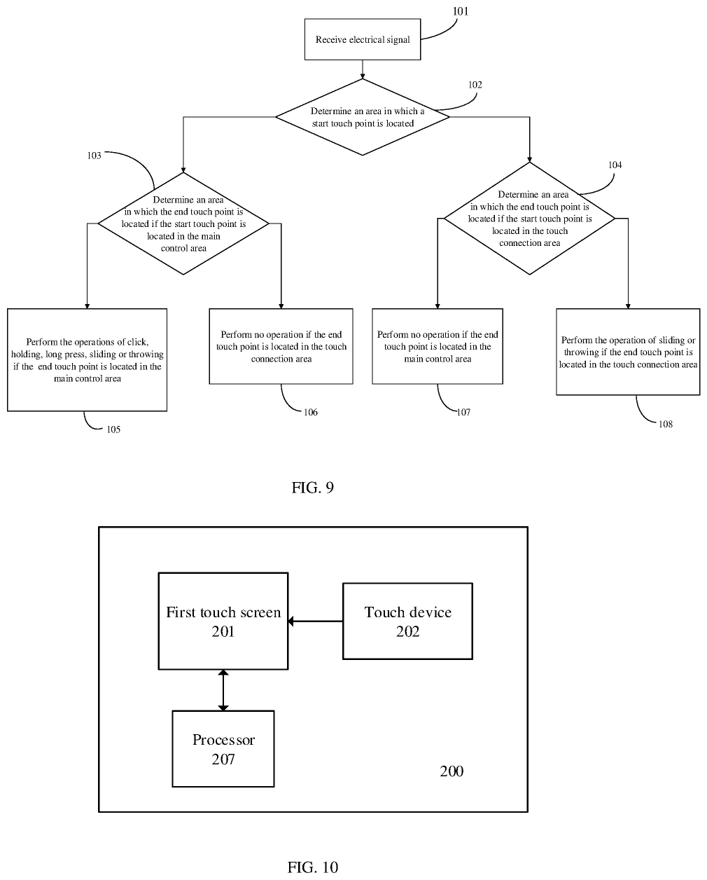

In some embodiments, as shown in FIG. 10, the display apparatus further includes a processor 207 arranged inside the apparatus. The processor 207 is connected to the first touch screen and is configured to: receive an electrical signal generated by a touch operation, and determine whether the touch operation meets a preset trigger condition or not, and if it is determined that the touch operation meets the preset trigger condition, recognize the electrical signal and transmit a control instruction to the first touch screen; and if it is determined that the touch operation does not meet the preset trigger condition, perform no operation. For example, the trigger condition may be that the touch operation is at least one of sliding and throwing. If the touch operation is at least one of sliding and throwing, a corresponding operation is performed; and if not, for example, if the touch operation is at least one of click, holding, long press or other operations, no operation is performed, thereby eliminating possible mis-touch phenomenon during a side touch process and improving the accuracy of the side touch.

For example, as shown in FIG. 5, the first touch screen includes a main control area A that is not in contact with the screen-side touch device, and a touch connection area B that is in contact with the screen-side touch device. Since the touch portion 1 is electrically connected to the touch connection area B through the electrical contact points 21, signals received by the processor 207 from the touch connection area B not only includes an electrical signal generated by a touch operation directly performed on the touch connection area B, but also includes an electrical signal generated by a touch operation directly performed on the touch portion 1. That is to say, performing a touch operation on the touch portion 1 is equivalent to performing a touch operation directly on the touch connection area B. The processor is further configured to determine positions of a start touch point and an end touch point when a touch operation is performed on the first touch screen, and perform a corresponding touch control operation (which may also be expressed as “touch determination logic operation”) according to a result of determination.

In some embodiments, the users may adjust position and size of the touch device relative to the display apparatus according to their own needs. Since a change in a position of the touch device may cause a system to fail to recognize new touch connection area B, an application may be installed on the display apparatus. The user may drag the position and the size of the touch connection area B through the application to update internal parameters of the system, so that the processor 207 may receive a signal of a changed touch connection area B.

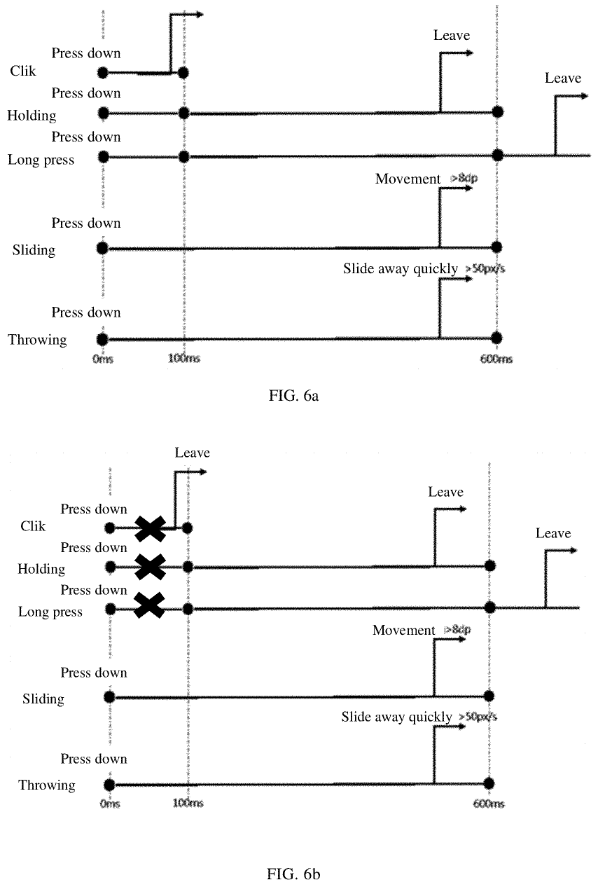

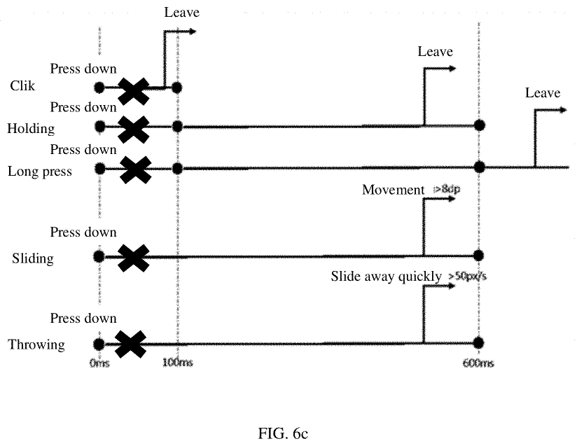

For example, the processor 207 determines whether the start touch point and the end touch point are located in a same touch screen area or not. If yes, that is, if the start touch point and the end touch point are both located in the main control area A, or both in the touch connection area B, a touch determination and operation of the corresponding touch screen area is performed; and if not, that is, if one of the start touch point and the end touch point is located in the main control area A and the other of the start touch point and the end touch point is located in the touch connection area B, the touch operation is determined to be invalid and no operation is performed in order to avoid mis-touch phenomenon, and a touch logic is shown in FIG. 6c.

For example, performing the touch determination and operation corresponding to the touch screen area includes: determining an area in which the start touch point and the end touch point are located; if the start touch point and the end touch point are both located in the main control area A, that is, the operation starts in the main control area A and ends in the main control area A, performing the touch determination and operation of the main control area A, that is, as shown in FIG. 6a, a touch logic is to perform at least one of click, holding, long press, sliding, and throwing according to rules of the touch determination; and if the start touch point and the end touch point are both located in the touch connection area B, performing the touch determination and operation of the touch connection area B, that is, as shown in FIG. 6b, a touch logic is to perform at least one of sliding and throwing according to rules of the touch determination. If the touch operation is determined to be at least one of click, holding, and long press, no operation is performed to avoid mis-touch.

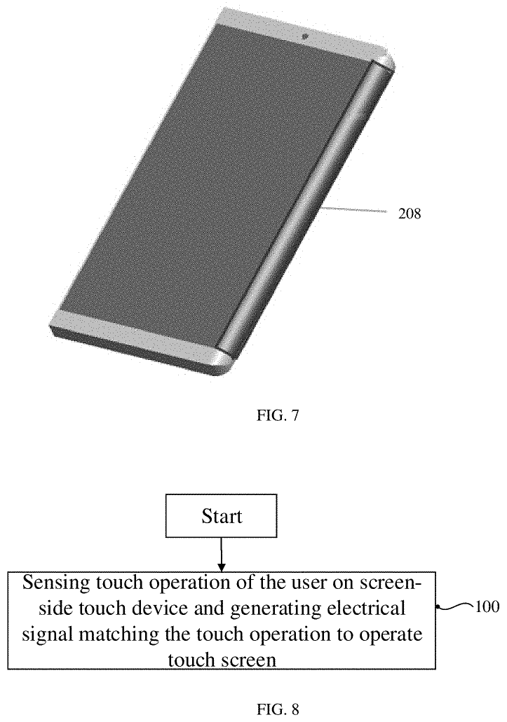

In some embodiments of the present disclosure, as shown in FIG. 7, the touch portion 1 is a second touch screen 208 connected to the processor 207 inside the apparatus. The second touch screen senses a touch operation from the user, generates an electrical signal matching the touch operation, and transmits the electrical signal to the processor 207. The processor transmits a control signal to the second touch screen to perform an operation on the second touch screen. In this embodiment, two operating modes may be designed for the screen-side touch device. In a first operating mode, the second touch screen may have same touch determination as the first touch screen, that is, it may perform any of the operations of click, holding, long press, sliding, and throwing, and the second touch screen may also have a display function. In a second operating mode, the second touch screen may only perform the operations of sliding and throwing, and only has a function of side sliding.

In the above-mentioned embodiment, the touch portion 1 senses the touch operations from the user and generates the electrical signals matching the touch operations so as to perform the operations including at least one of sliding and throwing on the touch screen.

In the screen-side touch device according to an embodiment of the present disclosure, the touch portion 1 of the screen-side touch device is arranged on the side wall of the apparatus with the touch screen, such that the user may operate the touch screen by operating the touch portion 1. Therefore, the user is provided with a new touch operation method, which not only avoids obstructing the user's sight when operating the touch screen and improves the user experience, but also reduces the possibility of user's joint strain caused by sliding the touch screen up and down through the thumb for a long time. Moreover, the touch logic is redesigned for the screen-side touch device to avoid mis-touch. In addition, the device has a simple structure and low cost and is easy for marketing and use.

A second aspect of the embodiments of the present disclosure proposes a method for controlling the touch screen, which is applied to the screen-side touch device described in any one of the above embodiments and used to solve possible mis-touch phenomenon. As shown in FIG. 8, the method includes step 100 of sensing a touch operation of a user on the screen-side touch device and generating an electrical signal matching the touch operation, so as to perform an operation on the touch screen.

In order to perform the operations on the touch screen, an embodiment of the present disclosure provides touch determination logic rules. FIG. 6a shows a schematic diagram of a first touch determination logic of the screen-side touch device according to an embodiment of the present disclosure, including: when a finger touches the screen and leaves within 100 ms, the system recognizes it as a click event; when a finger touches the screen and leaves within 100 ms to 600 ms, the system determines it as a holding event; when a finger touches the screen and leaves after 600 ms, the system recognizes it as a long press event; when a finger touches the screen and leaves within 600 ms with a finger movement greater than 8 dp, the system recognizes it as a sliding event; and when a finger touches the screen and slides away quickly within 600 ms at a speed of greater than 50 px/s, the system determines it as throwing.

In the embodiment of the present disclosure, the screen-side touch device is provided on a side surface of the touch screen. Since the electrical contact points 21 of the touch device are relatively scattered and a touchable interface of the side surface is relatively compact, when operating the touch portion 1, it may not be convenient to distinguish each electrical contact point, and there is a small probability of mis-touch. For the mis-touch, a presence of a click is first determined, and when it is determined that a screen sliding starts, the finger touches the touch portion 1 but leaves the screen without meeting the requirements of the sliding operation in the touch gesture determination logic, or the user thinks that there is sliding, but in fact the finger only touches the screen for a short time without substantial movement. Therefore, in order to eliminate possible mis-touch, the trigger condition may be preset for the touch operation sensed. For example, it may be determined whether the touch operation corresponding to the electric signal meets the preset trigger condition or not, and if so, the electric signal is recognized and a control instruction is transmitted to the touch screen, or otherwise, no operation is performed. Whether the touch operation is at least one of sliding and throwing or not.

In some embodiments, it is also possible to determine the positions of the start touch point and the end touch point when the touch operation is performed on the touch screen, and perform corresponding touch determination and operation according to the result of determination.

For example, the touch screen includes: a main control area that is not in contact with the screen-side touch device; and a touch connection area that is in contact with the screen-side touch device. Since the touch portion 1 is electrically connected to the touch connection area through the electrical contact points 21, the electrical signal generated in the touch portion 1 is directly transmitted to the touch connection area, and the signal received by the processor is transmitted from the touch connection area. Therefore, performing a touch operation on the touching portion 1 is equivalent to performing a touch operation directly on the touch connection area. The method further includes: determining whether the start touch point and the end touch point are located in the same touch screen area or not, that is, determining whether the start touch point and the end touch point are both located in the main control area or both in the touch connection area; and if yes, performing touch determination and operation corresponding to the touch screen area; and if not, that is, one of the start touch point and the end touch point is located in the main control area, and the other of the start touch point and the end touch point is located in the touch connection area, determining the touch operation to be invalid and performing no operation in order to avoid mis-touch, and a touch logic is shown in FIG. 6c.

For example, the performing the touch determination and operation corresponding to the touch screen area includes: determining an area in which the start touch point and the end touch point are located; and if the start touch point and the end touch point are both located in the main control area, performing the touch determination and operation of the main control area, that is, as shown in FIG. 6a, the touch logic is to perform at least one of click, holding, long press, sliding, and throwing according to rules of the touch determination; and if the start touch point and the end touch point are both located in the touch connection area, performing the touch determination and operation of the touch connection area, that is, as shown in FIG. 6b, the touch logic is to perform at least one of sliding and throwing according to rules of the touch determination. If the touch operation is determined to be at least one of click, holding, and long press according to the touch determination, no operation is performed to avoid mis-touch.

For example, if the start touch point and the end touch point are both located in the touch connection area, and the touch operation is determined to be at least one of click, holding, and long press, no operation is performed.

When the touch portion is a second touch screen, the second touch screen is connected to the processor inside the apparatus. The second touch screen senses the touch operations from the user, generates electrical signals matching the touch operations, and transmits the electrical signals to the processor. The processor transmits a control signal to the second touch screen to operate the second touch screen. In practice, two operating modes may be designed for the screen-side touch device. In the first operating mode, the second touch screen may have the same touch determination as the first touch screen, that is, it may perform any of the operations of click, holding, long press, sliding, and throwing, and the second touch screen may also have a display function. In the second operating mode, the second touch screen follows the touch logic described in the above embodiment, that is, it may only perform the operations of sliding and throwing, and only has the function of side sliding.

For example, the touch portion 1 is used to sense the touch operations from the user and generate the electrical signals matching the touch operations so as to perform the operations including at least one of sliding and throwing on the touch screen.

In order to make it easier to understand the touch control method described in the above-mentioned embodiment, an embodiment of the present disclosure provides a touch determination rule method. As shown in FIG. 9, the method may include: step 101, receiving an electrical signal generated based on a touch operation; step 102, determining an area in which the start touch point is located according to the electrical signal; step 103, if the start touch point is located in the main control area, determining an area in which the end touch point is located; step 105, if the end touch point is located in the main control area, that is, if the start and end points of the finger touch on the touch screen are both located in the main control area of the touch screen, performing an operation of click, holding, long press, sliding, or throwing according to the electrical signal, where the touch gesture determination logic is shown in FIG. 6a; and step 106, if the end touch point is located in the touch connection area, that is, if the start point of the finger touch on the touch screen is located in the main control area of the touch screen and the end point is located in the touch connection area, performing no operation, where the touch gesture determination logic is shown in FIG. 6c.

For example, the method for controlling the touch screen further includes: step 104: if the start touch point is located in the touch connection area, that is, the user's finger touches the touch connection area or the touch portion 1, determining an area in which the end touch point is located; step 107: if the end touch point is located in the main control area, that is, the start point of the finger touch on the touch screen is located in the touch connection area and the end point of the finger touch on the touch screen is located in the main control area of the touch screen, performing no operation, where the touch gesture determination logic is shown in FIG. 6c; and step 108: if the end touch point is located in the touch connection area, that is, the start and end points of the finger touch on the touch screen are both located in the touch connection area or both in the touch portion 1, performing the operation of sliding or throwing according to the electrical signal, where the touch gesture determination logic is shown in FIG. 6b.

Through the method for controlling the touch screen described in this embodiment, the side touch function may be effectively and accurately achieved, and the possible mis-touch phenomenon during the side touch process of the terminal may be eliminated, which provides the user with a more friendly screen-side touch device to improve user experience.

A third aspect of the embodiments of the present disclosure proposes a terminal apparatus, including a terminal apparatus body with a touch screen and the screen-side touch device according to any one of the above embodiments.

As described above, in the screen-side touch device, the screen-side touch method, and the display apparatus provided by the embodiments of the present disclosure, the touch portion is fixed to the side wall of the apparatus when in use. When the user's finger operates the touch portion 1 located on the side wall of the apparatus, the touch portion 1 senses the touch operations from the user's finger and generates electrical signals matching the touch operations. Since the touch device is electrically connected to the touch screen, a touch control signal corresponding to the electrical signal is generated and transmitted to the touch screen, so as to perform the operation on the touch screen. The screen-side touch device provided by the embodiments of the present disclosure provides a new touch operation method. On the one hand, it avoids obstructing the user's sight when operating the touch screen and improves the user experience. On the other hand, it reduces the possibility of user's joint strain caused by sliding the touch screen up and down through the thumb for a long time.

Those ordinary skilled in the art should understand that the discussion of any of the above embodiments is only exemplary, and is not intended to imply that the scope of the present disclosure (including the claims) is limited to these examples. Under the idea of the present disclosure, the above embodiments or the technical features in different embodiments may also be combined, the steps may be carried out in any order, and there are many other changes in different aspects of the present disclosure as described above, which are not provided in details for the sake of simplicity

In addition, to simplify the description and discussion, and in order not to obscure the present disclosure, well-known power sources/ground connections to integrated circuit (IC) chips and other components may or may not be shown in the drawings provided. In addition, the device may be shown in the form of block diagrams in order to avoid making the present disclosure difficult to understand, and this also takes into account the fact that the details of the implementation of these block diagram devices are highly dependent on the platform on which the present disclosure is to be implemented (that is, these details should be fully within the understanding of those skilled in the art). In the case where details (for example, circuits) are described for exemplary embodiments of the present disclosure, it is obvious to those skilled in the art that the present disclosure may be implemented without these details or with changes in these details. Therefore, these descriptions should be considered illustrative rather than restrictive.

Although the present disclosure has been described in conjunction with the embodiments of the present disclosure, based on the foregoing description, many substitutions, modifications and variations of these embodiments are apparent to those ordinary skilled in the art. For example, the discussed embodiments may be used for other memory architectures (for example, dynamic RAM (DRAM)).

The embodiments of the present disclosure are intended to cover all substitutions, modifications and variations that fall within the broad scope of the appended claims. Therefore, any omission, modification, equivalent replacement, improvement, and so on made within the spirit and principle of the present disclosure should be included in the protection scope of the present disclosure.

1. A display apparatus, comprising:
a first touch screen; and
a touch device comprising a touch portion and an electrical connection portion, wherein the touch portion is on a side of the first touch screen and is electrically connected to the first touch screen through the electrical connection portion, the touch portion is configured to generate an electrical signal in response to a touch operation of a user on the touch portion and provide the generated electrical signal to the first touch screen through the electrical connection portion to perform a touch control operation.

2. The display apparatus according to claim 1, wherein the first touch screen is a capacitive touch screen; and
wherein the touch portion comprises at least two conductive units electrically isolated from each other, with one ends of the conductive units electrically connected to the first touch screen through the electrical connection portion, and the other ends of the conductive units arranged in parallel on a side of the first touch screen.

3. The display apparatus according to claim 2, wherein the other ends of the conductive units are arranged in a direction parallel or perpendicular to a side of the first touch screen.

4. The display apparatus according to claim 3, wherein the electrical connection portion comprises a plurality of connection pads, and one ends of the at least two conductive units are electrically connected to the first touch screen through the plurality of connection pads, respectively; and
wherein the touch device further comprises a flexible substrate configured to fix the touch portion to a side of the first touch screen and fix the connection pads to the first touch screen.

5. The display apparatus according to claim 4, further comprising a sealing protection layer covering the at least two conductive units and the connection pads, wherein the sealing protection layer seals the at least two conductive units and the connection pads as a whole.

6. The display apparatus according to claim 1, further comprising a touch screen protection film, wherein the electrical connection portion and at least a part of the touch portion are between the touch screen protection film and the first touch screen.

7. The display apparatus according to claim 4, further comprising an apparatus protection housing, wherein the first touch screen and the touch device are inside the apparatus protection housing, and the apparatus protection housing is provided with a through hole configured to expose the touch portion of the touch device.

8. The display apparatus according to claim 1, wherein the touch device further comprises a transition portion, and the touch portion and the electrical connection portion are connected through the transition portion.

9. The display apparatus according to claim 1, further comprising a processor inside the display apparatus, wherein the processor is connected to the first touch screen and is configured to: receive an electrical signal generated by the touch operation, determine whether the touch operation meets a preset trigger condition or not, and if the touch operation meets the preset trigger condition, generate a control instruction based on the electrical signal and transmit the control instruction to the first touch screen.

10. The display apparatus according to claim 9, wherein the preset trigger condition comprises that whether the touch operation is at least one of sliding and throwing or not.

11. The display apparatus according to claim 9, wherein the first touch screen comprises a main control area and a touch connection area, and the electrical connection portion of the touch device is electrically connected to the first touch screen in the touch connection area; and
wherein the processor is further configured to determine positions of a start touch point and an end touch point of the touch operation performed on the first touch screen, and perform a touch control operation according to a result of determination.

12. The display apparatus according to claim 11, wherein the processor is configured to: determine whether the start touch point and the end touch point are in one of the main control area and the touch connection area or not; and
wherein if it is determined that the start touch point and the end touch point are in one of the main control area and the touch connection area, performing the touch control operation of the main control area or the touch connection area; and
if it is determined that the start touch point and the end touch point are not in one of the main control area and the touch connection area, performing no operation.

13. The display apparatus according to claim 12, wherein the performing the touch control operation of the main control area or the touch connection area comprises:
determining whether the start touch point and the end touch point are in the main control area or in the touch connection area; and
wherein if it is determined that the start touch point and the end touch point are both in the main control area, performing the touch control operation of the main control area; and
if it is determined that the start touch point and the end touch point are both in the touch connection area, performing the touch control operation of the touch connection area.

14. The display apparatus according to claim 1, wherein the touch portion is a second touch screen connected to a processor inside the display apparatus, and the second touch screen is configured to generate an electrical signal in response to a touch operation of the user on the second touch screen and transmit the electrical signal to the processor, to cause the processor to transmit a control signal to the second touch screen to perform a touch control operation on the second touch screen.

15. The display apparatus according to claim 1, wherein the touch operation comprises at least one of sliding and throwing.

16. A touch control method implemented by the display apparatus according to claim 1, comprising:
generating an electrical signal in response to a touch operation of a user on the touch device; and
performing a touch control operation based on the electrical signal.

17. The method according to claim 16, further comprising:
determining positions of a start touch point and an end touch point when the touch operation is performed on the first touch screen; and
performing the touch control operation based on a result of determination.

18. The method according to claim 17, wherein the first touch screen comprises a main control area and a touch connection area, and the electrical connection portion of the touch device is electrically connected to the first touch screen in the touch connection area, the method further comprising:
determining whether the start touch point and the end touch point are in one of the main control area and the touch connection area or not; and
wherein if it is determined that the start touch point and the end touch point are in one of the main control area and the touch connection area, performing the touch control operation of the main control area or the touch connection area; and
if it is determined that the start touch point and the end touch point are not in one of the main control area and the touch connection area, performing no operation.

19. The method according to claim 18, wherein the performing the touch control operation of the main control area or the touch connection area comprises:
determining whether the start touch point and the end touch point are in the main control area or in the touch connection area; and
wherein if it is determined that the start touch point and the end touch point are both in the main control area, performing the touch control operation of the main control area; and
if it is determined that the start touch point and the end touch point are both in the touch connection area, performing the touch control operation of the touch connection area.

20. The method according to claim 16, wherein the touch portion is a second touch screen connected to a processor inside the display apparatus, and the second touch screen is configured to generate an electrical signal in response to the touch operation of the user on the second touch screen and transmit the electrical signal to the processor, to cause the processor to transmit a control signal to the second touch screen to perform a touch control operation on the second touch screen,
wherein the second touch screen is configured to generate the electrical signal in response to the touch operation of the user on the second touch screen to perform operations comprising at least one of sliding and throwing on the second touch screen.

21. (canceled)
